(19) United States
(12) Patent Application Publication
(10) Pub. No.: US 2009/0197569 A1
(43) Pub. Date: Aug. 6, 2009

(54) SYSTEM AND METHOD FOR ENHANCING SECURITY FOR A MOBILE ELECTRONIC DEVICE OPERATED BY A CHILD

(76) Inventors: Zobeideh Gaznaghi, Lund (SE); Rogier Kamerbeek, Emmen (NL); Jacobus Haartsen, Hardenberg (NL)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/025,075

(22) Filed: Feb. 4, 2008

(51) Int. Cl. H04M 1/66

(52) U.S. Cl. 455/410

(57) ABSTRACT

To enhance security related to an electronic device used by a child, communications involving the electronic may be monitored. When the child's electronic device receives a call or other form of communication from an unknown device, identification information about the unknown device may be forwarded to an electronic device of a parent or other supervisor. Also, when the child initiates a communication with another device, the electronic device of the parent or other supervisor may receive a notification.

### TECHNICAL FIELD OF THE INVENTION

The technology of the present disclosure relates generally to mobile electronic devices and, more particularly, to a system and method for enhancing the security associated with a mobile electronic device that is operated by a child.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces.

Children are frequent users of portable electronic devices. Unfortunately, however, a child user of a mobile electronic device is particularly vulnerable to an unscrupulous person who initiates contact with the child using a communications method associated with the electronic device. Also, a child user is vulnerable to accessing inappropriate content over a network.

### SUMMARY

To enhance the security related to electronic devices used by children, the present disclosures describes techniques to provide parental (or other adult) supervision over communicates involving a child's electronic device. In one embodiment, when a child's electronic device receives a call (or other form of communication) from an unknown device, identification information about the unknown device (e.g., a telephone number and/or user name) may be forwarded to an electronic device of a parent or other supervisor. In another embodiment, when the child initiates a communication, the electronic device of the parent or other supervisor may receive a notice.

According to one aspect of the disclosure, a first method of monitoring communications associated with a mobile electronic device includes determining if a communication destined to the mobile electronic device is from a previously identified source and, if not, transmitting a notification of the communication to a supervisor's electronic device to inform a user of the supervisor's electronic device of the communication.

According to one embodiment of the first method, the communication is one of a call or a message.

According to one embodiment of the first method, the communication is a file or data transfer.

According to one embodiment of the first method, the communication is a chat session.

According to one embodiment of the first method, the notification is transmitted in the form of a message.

According to one embodiment of the first method, the communication is allowed to take place if the source is not previously identified.

According to one embodiment of the first method, the communication is not allowed to take place if the source is not previously identified.

According to one embodiment of the first method, if the source is not previously identified, the communication is not allowed to take place until the user of the supervisor's electronic device authorizes the communication.

According to one embodiment of the first method, identification information for previously identified sources is maintained in a contact list.

According to one embodiment, the first method further includes upon initiation of a communication by the mobile electronic device, transmitting a notification of the initiated communication to the supervisor's electronic device to inform the user of the supervisor's electronic device of the initiated communication.

According to another aspect of the disclosure, a second method of monitoring communications associated with a mobile electronic device includes upon initiation of a communication involving the mobile electronic device, transmitting a notification of the communication to a supervisor's electronic device to inform a user of the supervisor's electronic device of the communication.

According to one embodiment of the second method, the communication is one of a call or a message.

According to one embodiment of the second method, the communication is a file or data transfer.

According to one embodiment of the second method, the communication is a chat session.

According to one embodiment of the second method, the notification is transmitted in the form of a message.

According to one embodiment, the second method further includes blocking in the communication if a source or destination of the communication is not previously identified.

According to one embodiment, the second method further includes blocking in the communication until the user of the supervisor's electronic device authorizes the communication.

According to one embodiment of the second method, the communication is initiated with the mobile electronic device.

According to another aspect of the disclosure, a first program stored on a computer readable medium monitors communications associated with a mobile electronic device and includes executable logic to determine if a communication destined to the mobile electronic device is from a previously identified source and, if not, transmit a notification of the communication to a supervisor's electronic device to inform a user of the supervisor's electronic device of the communication.

According to one embodiment, the first program further includes logic to transmit a notification of a communication initiated with the mobile electronic device to the supervisor's electronic device to inform the user of the supervisor's electronic device of the initiated communication.

According to another aspect of the disclosure, a second program stored on a computer readable medium monitors communications associated with a mobile electronic device and includes executable logic to transmit a notification of a communication involving the mobile electronic device to the supervisor's electronic device to inform the user of the supervisor's electronic device of the communication.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic diagram of a representative communication system in which electronic devices associated with a child, a parent and a third party may operate;

FIG. 2 is a schematic block diagram that represents an exemplary system architecture for electronic devices associated with the child and/or the parent;

FIG. 3 is a flow chart representing a first exemplary method of enhancing security of the child's electronic device; and

FIG. 4 is a flow chart representing a second exemplary method of enhancing security of the child's electronic device.

### DETAILED DESCRIPTION OF EMBODIMENTS

Embodiments will now be described with reference to the drawings, wherein like reference numerals are used to refer to like elements throughout. It will be understood that the figures are not necessarily to scale.

In the present document, embodiments are described primarily in the context where various electronic devices are associated with a child user, a parent user and a third party user. It will be appreciated, however, that other types of users may be associated with the various devices. Also, the representative electronic devices are in the form of mobile telephones. But it will be appreciated that aspects of the disclosed systems and methods may involve any type of appropriate electronic devices. Therefore, each electronic device described in this document may be a mobile telephone, a media player, a gaming device, a personal digital assistant (PDA), a computer, a pager, a communicator, an electronic organizer, a smartphone, a portable communication apparatus or other similar device.

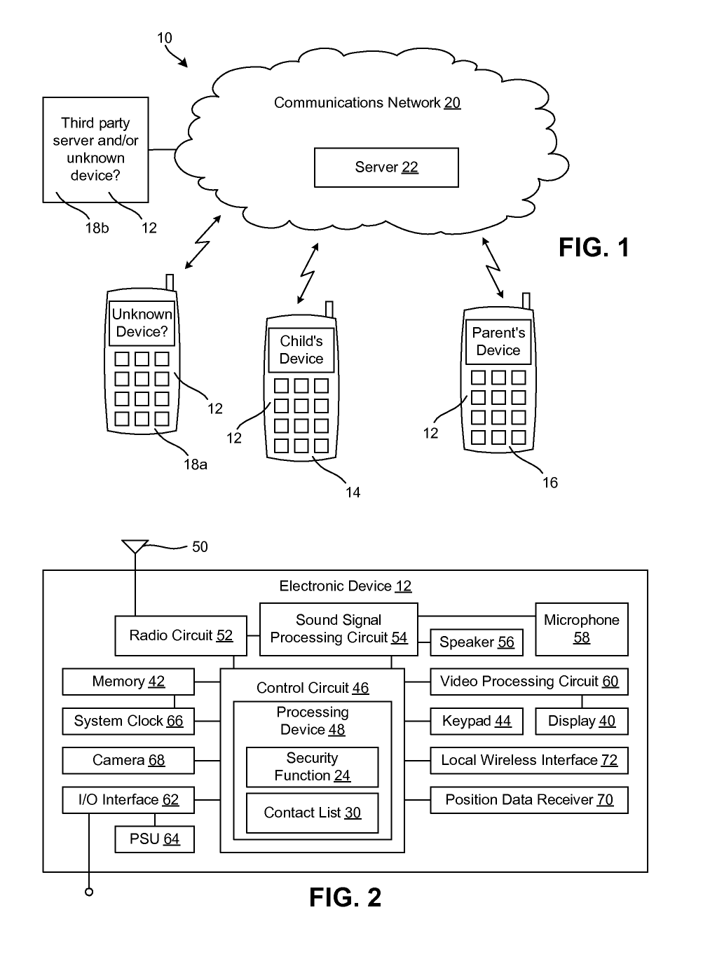

Initially referring to FIG. 1, shown is an exemplary communication system 10 in which electronic devices 12 may operate. In the illustrated embodiment, the electronic devices 12 may include a first electronic device 14 that is operated by a child user. The first electronic device 14 also will be referred to as the child's device 14. The electronic devices 12 also may include a second electronic device 16 that is operated by a parent of the child. The second electronic device 16 also will be referred to as the parent's device 16. It is noted that the second electronic device 16 may be operated by a person who is not a parent of the child, but by a person who is interested in the well-being of the child, such as a relative (e.g., grandparent, uncle, aunt, etc.), a guardian, a “baby sitter,” a school administrator, or other individual. As such, the second electronic device 16 also may be referred to as a supervisor's device 16. For simplicity, the term parent will be used to describe the user of the second electronic device, even though the user of the second electronic device 16 need not be the parent of the user of the first electronic device 14.

The electronic devices 12 may include one or more electronic devices 18 that are operated by a third party. In the illustrated example, there is a mobile device 18a that is associated with a third party user and a device 18b connected to the network 20. The device 18b may provide a service, such as an Internet site, a push service (e.g., a subscription ring-tone service), a pull service (e.g., a streaming service), etc. In some circumstances, the third party may be a person (e.g., the user of the device 18a) or an automated system (e.g., the device 18b) that is known to the user of the first electronic device 14 and/or the second electronic device 16, and is trusted to engage in communications with the child. In other circumstances, the third party may be a person or system that is not known to the user of the first electronic device 14 and/or the second electronic device 16, and/or is not trusted to engage in communications with the child. The systems and methods described below may assist in distinguishing between these situations and provide monitoring of communications involving the child's device 14.

As used in this document, communications may relate to various data exchanges or transmissions involving the child's device 14. Exemplary forms of communication may include calls (e.g., telephone calls, video calls, etc.), messages (e.g., text messages, multimedia messages, electronic mail messages, instant messages, etc.), file and/or data transfers (e.g., downloads, uploads, data pushes, data pulls, data feeds, streaming audio, streaming video, an RSS feed, interaction with an Internet site, etc.), etc.), chat sessions, push-to-talk exchanges, pages, and so forth.

The communications system 10 may include a communications network 20 having a server 22 (or servers) for managing calls placed by and destined to the electronic devices 12, handling data sent to and transmitted by the electronic devices 12, and carrying out any other support functions. The server 22 may communicate with each electronic device 12 via a transmission medium. The transmission medium may be any appropriate device or assembly including, for example, a communications tower (e.g., a cell tower), a base station, a wireless access point, a satellite, etc. The network 20 may support the communications activity of multiple electronic devices 12 and other types of end user devices. In the illustrated example, each of the mobile devices 14, 16 and 18a are supported by the network 20, which is likely to be operated by a service provider. It is noted that one or more of the mobile devices may be supported by a different network that is operated by a different service provider. Any additional networks that support mobile devices and/or support other devices, such as the device 18b, may communicate with the network 20 so that data may be exchanged between and among the various devices 12. As will be appreciated, the server 22 may be configured as a typical computer system used to carry out server functions and may include a processor configured to execute software containing logical instructions that embody the functions of the server 22 and a memory to store such software.

With additional reference to FIG. 2, the child's electronic device 14 and/or the parent's electronic device 16 may include a security function 24 that is configured to keep the parent informed of certain events involving the child's electronic device 14. Additional details and operation of the security function 24 will be described in greater detail below. The security function 24 may be embodied as executable code that is resident in and executed by the electronic device 14 and/or 16. In one embodiment, the security function 24 may be a program stored on a computer or machine readable medium. The security function 24 may be a stand-alone software application or form a part of a software application that carries out additional tasks related to the electronic device 12.

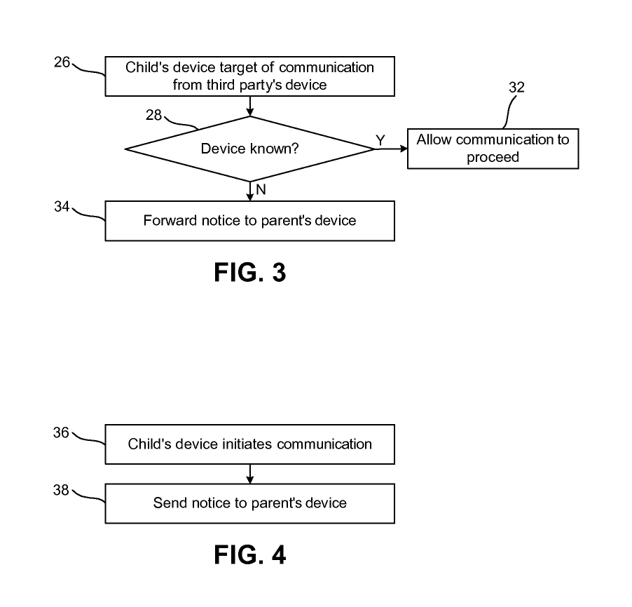

With additional reference to FIG. 3, illustrated are logical operations to implement an exemplary method of monitoring activity of the child's electronic device 14. The exemplary method may be carried out by executing an embodiment of the security function 24, for example. Some of the steps may be carried out by the child's device 14 and some of the steps may be carried out by the parent's device 16. In other embodiments, some of the steps may be carried out by the server 22, as will be described below. Thus, the flow chart of FIG. 3 may be thought of as depicting steps of methods carried out by the device 14, the device 16 and/or the server 22. Although FIG. 3 shows a specific order of executing functional logic blocks, the order of executing the blocks may be changed relative to the order shown. Also, two or more blocks shown in succession may be executed concurrently or with partial concurrence. Certain blocks also may be omitted.

The logical flow may start in block 26 where the child's device 14 becomes the target of a communication from the third party's device 18. As indicated, the communication may be a call, a message, a file or data transfer, an initiation of a chat session or some other data exchange. Thereafter, in block 28 a determination may be made as to whether the third party's device 18 is known as a trusted source for the communication. In one embodiment, the determination of block 28 may be made by comparing an identifier associated with the third party's device 18 against known identification information as stored by a contact list 30 (FIG. 2). This comparison may be carried out by the child's device 14, the parent's device 16 or the server 22. The format of the identifier may depend on the type of communication. For example, for telephone calls, video calls and some types of messages, the identifier may be a telephone number associated with the third party's device 18. Other exemplary identifiers include an electronic mail address, an internet protocol (IP) address, a user name, a device name, a uniform resource locator (URL), or other identification mechanism. If the identifier is stored as part of the contact list 30, then a conclusion may be made that the third party's device 18 is a “known” device and a positive determination may be made in block 28.

In one embodiment, the user of parent's device 16 may have control over the contents of the contact list 30. For example, if the contact list 30 is maintained by the child's device 14, the contact list 30 may be synchronized with a coordinating contact list 30 maintained by the parent's device 16. The user of the parent's device 16 may participate in the management of the contact list 30 so that contact list entries may be present for known third party devices 18 that are associated with trusted individuals or trusted automated systems. In this manner, if a previously identified device 18 initiates a communication with the child's device 14, a positive determination may be made in block 28. In another embodiment, the contact list 30 used for making the determination of block 28 may be maintained by the server 22 or the parent's device 16. The contact list 30 may be a conventional contact list used to store name and contact information for various individuals. In another embodiment, the contact list 30 may be a dedicated list or database used for making the determination of block 28.

If a positive determination is made in block 28, the logical flow may proceed to block 32. In block 32, the communication may be allowed to proceed. For instance, if the communication is a telephone call, the call may be put through to the child's device 14 as would normally occur for telephone calls.

A negative determination may be made in block 28 if the identifier associated with the third party's device 18 is not present in the contact list 30. Upon a negative determination in block 28, the logical flow may proceed to block 34. In block 34, the identity information for the third party's device 18 that initiated the communication may be forwarded to the parent's device 16 so that the user of the parent's device 16 may be made aware that an “unknown” third party device 18 has initiated a communication with the child's device 14. In one embodiment, the notice may be transmitted to the parent's device 16 even if a positive determination is made in block 28.

The notification may take any appropriate form, such as a, voice message, a text message, multimedia message, electronic mail message, instant message or other communication. The notification may include information about the type of communication, the date and time of the communication, and identifying information for the third party device 18, such as telephone number, user name, electronic mail address, and so forth. Notifications that are received by the parent's device 16 may be stored in a log or database so that the notifications may be browsed and managed by the user of the parent's device 16.

In one embodiment, the communication may be forwarded to the parent's device 16 in addition to the notification. For instance, if the communication is a telephone call, the call may be routed to the parent's device 16 to be answered by the user of the parent's device 16 rather than by the user of the child's device 14. As another example, if the communication is a message, the message may be delivered to the parent's device 16. In this manner, the user of the parent's device 16 may screen the communication. However, in most operational contexts it is contemplated that the communication may be allowed to proceed as if the third party's device 18 were a known device. But, since the identity of the third party's device 18 is communicated to the parent's device 16 in block 34, the user of the parent's device 16 may be made aware that the communication took place.

In one embodiment, the various manners in which to proceed following a communication from an unknown third party device 18 may be determined in advance by a configuration of user options established by the user of the parent's device 16. In addition to the above described embodiments, additional factors may be taken into consideration. For example, the security function 24 may analyze the day of the week, the time of day, the location of the child's device 14 (e.g., if the child's device 14 is at school, at home, at another known location, or an unknown location) the location of the parent's device 16 relative to the location of the child's device 14, the identity of the third party device 18, and so forth. In this manner, the security function 24 may be configured to automatically determine whether to forward the communication to the parent's device 16, block the communication from reaching the child's device 14 or the user of the child's device 14, allow the communication to proceed without any action on the part of the user of the parent's device 16, allow the communication to proceed following authorization by the user of the parent's device 16, or take some other action.

In one embodiment, the user of the parent's device 16 may be provided with an option to add identity information for the third party's device 18 associated with a communication to the contact list 30. In this manner, future communication from the third party's device 18 may generate a positive determination in block 28. In another embodiment, the user of the parent's device 16 may be provided with an option to add identity information for the third party's device 18 to a list or database of third party devices 18 that will automatically be deemed as “unknown” in block 28. Settings may be used to automatically block communications from one or more devices in this list or database from reaching the child's device 14 or the user of the child's device 14.

With additional reference to FIG. 4, illustrated are logical operations to implement another exemplary method of monitoring activity of the child's electronic device 14. The exemplary method may be carried out by executing an embodiment of the security function 24, for example. Some of the steps may be carried out by the child's device 14 and some of the steps may be carried out by the parent's device 16. In other embodiments, some of the steps may be carried out by the server 22, as will be described below. Thus, the flow chart of FIG. 4 may be thought of as depicting steps of methods carried out by the device 14, the device 16 and/or the server 22. Although FIG. 4 shows a specific order of executing functional logical blocks, the order of executing the blocks may be changed relative to the order shown. Also, two or more blocks shown in succession may be executed concurrently or with partial concurrence. Certain blocks also may be omitted.

The logical flow may begin in block 36 in which the child's device 14 is used to initiate a communication to another electronic device 12. The initiation of a communication may include, for example, the placing of a call, the sending of a message, the initiation of a file or data transfer, accessing an Internet site, accessing a service hosted by another device, or other similar action as described above. Next, in block 38, the child's device 14 or the server 22 may send a notice to the parent's device 16 that the child's device 14 initiated the communication. In one embodiment, the notice may be in the form of a text message. Other formats for the notice are possible, such as a voice message, an electronic mail message, a multimedia message and instant message and so forth. The notice may contain various items of information, such as the type of communication, contact information for the destination of the communication, a time stamp for the communication (e.g., a date and a time), and so forth. The contact information for the destination electronic device 12 may be, for example, a telephone number, an electronic mail address, a user name, a device name, a URL, and so forth. The contact information may be extracted from information that is manually entered by the user of the child's device 14, from a contact list 30 of the child's device 14, or from a contact list 30 or database maintained by the parent's device 16 or the server 22. The transmission of the notice to the parent's device 16 may allow the user of the parent's device 16 to be aware of the usage behavior of the child's device 14. In this manner, the user of the parent's device 16 may be vigilant in monitoring the activity of the user of the child's device 14. In one embodiment, the notices may be stored in a log or database so that the user of the parent's device 16 may access and browse a history of notices. The notices also may be managed, such as deleting notices, searching notices, sorting notices, etc.

In one embodiment, a notice may be sent for any communication that is initiated with the child's device 14. In another embodiment, a notice may be sent only if the communication meets predetermined criteria, such as type of communication, identity of the destination, whether the destination of the communication is known or unknown (which may be determined using the contact list 30), day of the week, time of day, location of the child's device 14, etc.

In one embodiment, the user of the child's device 14 may be allowed to initiate communications as he or she pleases. In other embodiments, it may be possible to allow the user of the parent's device 16 to block or require pre-authorization from the parent's device 16 for various communications initiated with the child's device. A determination to block or require pre-authorization for a communication may be made automatically by the security function 24 or based on action of the user of the parent's device 16. For instance, pre-established user settings of the security function 24 may be set to allow the communication to proceed, block the communication from proceeding, obtain authorization from the user of the parent's device 16 before allowing the communication to proceed, and so forth. This determination may be based on various factors, such as the day of the week, the time of the day, the type of communication, the identity of the destination for the communication (e.g., whether the destination is present in the contact list 30 or present on a list of destinations to which communications are to be blocked), and so forth. In one embodiment, the user of the parent's device 16 may be provided with an option to add the destination of a communication, as identified in a notice sent in block 38, to the contact list 30 or to a list of destinations to which communications are to be blocked.

In the described embodiments, the methods of overseeing communications of a child's device 14 are described in the context of a parent or other supervisor monitoring and/or controlling the communications of a child user. The involvement of the parent's device 16 in the communication activity of the child's device 14 may lead to protecting the user of the child's device 14 from unscrupulous individuals. The involvement of the parent's device 16 in the communication activity of the child's device 14 also may minimize the exposure of the user of the child's device to content that may be inappropriate, such as content from an inappropriate Internet site (e.g., a site with pornographic content). The involvement of the parent's device 16 in the communication activity of the child's device 14 also may minimize involvement in transactions with unintended financial costs, such as the use of an inappropriate push service (e.g., a subscription ring-tone service that the child may have subscribed to without knowing the financial implications). It will be appreciated that these methods may be applied in other operational contexts. For example, these methods may be used by an employer to monitor and/or control the usage behavior of an employee.

With renewed reference to FIG. 2, additional details of the electronic device 14 and/or 16, when implemented as a mobile telephone, will be described. For this description, the electronic device 14 and/or 16, will be referred to generically as electronic device 12. The electronic device 12 is shown as having a “brick” or “block” form factor housing, but it will be appreciated that other housing types may be utilized, such as a “flip-open” form factor (e.g., a “clamshell” housing), a slide-type form factor (e.g., a “slider” housing), or a “pivot” form factor.

The electronic device 12 may include a display 40. The display 40 displays information to a user such as operating state, time, telephone numbers, contact information, various menus, etc., that enable the user to utilize the various features of the electronic device 12. The display 40 also may be used to visually display content received by the electronic device 12 and/or retrieved from a memory 42 (FIG. 2) of the electronic device 12. The display 40 may be used to present images, video and other graphics to the user, such as photographs, mobile television content and video associated with games.

A keypad 44 provides for a variety of user input operations. For example, the keypad 44 may include alphanumeric keys for allowing entry of alphanumeric information such as telephone numbers, phone lists, contact information, notes, text, etc. In addition, the keypad 44 may include special function keys such as a “call send” key for initiating or answering a call, and a “call end” key for ending or “hanging up” a call. Special function keys also may include menu navigation and select keys to facilitate navigating through a menu displayed on the display 40. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 40. Also, the display 40 and keypad 42 may be used in conjunction with one another to implement soft key functionality.

The electronic device 12 includes call circuitry that enables the electronic device 12 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The electronic device 12 may be configured to transmit, receive and/or process data, such as text messages, instant messages, electronic mail messages, multimedia messages, image files, video files, audio files, ring tones, streaming audio, streaming video, data feeds (including podcasts and really simple syndication (RSS) data feeds), and so forth. It is noted that a text message is commonly referred to by some as “an SMS,” which stands for simple message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 42, executing applications to allow user interaction with the data, displaying video and/or image content associated with the data, outputting audio sounds associated with the data, and so forth.

The electronic device 12 includes a primary control circuit 46 that is configured to carry out overall control of the functions and operations of the electronic device 12. The control circuit 46 may include a processing device 48, such as a central processing unit (CPU), microcontroller or microprocessor. The processing device 48 executes code stored in a memory (not shown) within the control circuit 46 and/or in a separate memory, such as the memory 42, in order to carry out operation of the electronic device 12. The processing device 48 may execute code that embodies the security function 24. It will be apparent to a person having ordinary skill in the art of computer programming, and specifically in application programming for mobile telephones or other electronic devices, how to program a electronic device 12 to operate and carry out logical functions associated with the security function 12. Accordingly, details as to specific programming code have been left out for the sake of brevity. Also, while the security function 12 is executed by the processing device 48 in accordance with an embodiment, such functionality could also be carried out via dedicated hardware or firmware, or some combination of hardware, firmware and/or software.

The memory 42 may be, for example, one or more of a buffer, a flash memory, a hard drive, a removable media, a volatile memory, a non-volatile memory, a random access memory (RAM), or other suitable device. In a typical arrangement, the memory 42 may include a non-volatile memory (e.g., a NAND or NOR architecture flash memory) for long term data storage and a volatile memory that functions as system memory for the control circuit 46. The volatile memory may be a RAM implemented with synchronous dynamic random access memory (SDRAM), for example. The memory 42 may exchange data with the control circuit 46 over a data bus. Accompanying control lines and an address bus between the memory 42 and the control circuit 46 also may be present.

Continuing to refer to FIG. 2, the electronic device 12 includes an antenna 50 coupled to a radio circuit 52. The radio circuit 52 includes a radio frequency transmitter and receiver for transmitting and receiving signals via the antenna 50. The radio circuit 52 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 68 and the radio circuit 70 may represent one or more than one radio transceiver.

The electronic device 12 further includes a sound signal processing circuit 54 for processing audio signals transmitted by and received from the radio circuit 52. Coupled to the sound processing circuit 54 are a speaker 56 and a microphone 58 that enable a user to listen and speak via the electronic device 12. The radio circuit 52 and sound processing circuit 54 are each coupled to the control circuit 46 so as to carry out overall operation. Audio data may be passed from the control circuit 46 to the sound signal processing circuit 54 for playback to the user. The audio data may include, for example, audio data from an audio file stored by the memory 42 and retrieved by the control circuit 46, or received audio data such as in the form of streaming audio data from a mobile radio service. The sound processing circuit 54 may include any appropriate buffers, decoders, amplifiers and so forth.

The display 40 may be coupled to the control circuit 46 by a video processing circuit 60 that converts video data to a video signal used to drive the display 40. The video processing circuit 60 may include any appropriate buffers, decoders, video data processors and so forth. The video data may be generated by the control circuit 46, retrieved from a video file that is stored in the memory 42, derived from an incoming video data stream that is received by the radio circuit 52 or obtained by any other suitable method.

The electronic device 12 may further include one or more I/O interface(s) 62. The I/O interface(s) 62 may be in the form of typical mobile telephone I/O interfaces and may include one or more electrical connectors. As is typical, the I/O interface(s) 62 may be used to couple the electronic device 12 to a battery charger to charge a battery of a power supply unit (PSU) 64 within the electronic device 12. In addition, or in the alternative, the I/O interface(s) 62 may serve to connect the electronic device 12 to a headset assembly (e.g., a personal handsfree (PHF) device) that has a wired interface with the electronic device 12. Further, the I/O interface(s) 62 may serve to connect the electronic device 12 to a personal computer or other device via a data cable for the exchange of data. The electronic device 12 may receive operating power via the I/O interface(s) 62 when connected to a vehicle power adapter or an electricity outlet power adapter. The PSU 64 may supply power to operate the electronic device 12 in the absence of an external power source.

The electronic device 12 also may include a system clock 66 for clocking the various components of the electronic device 12, such as the control circuit 46 and the memory 42.

The electronic device 12 may include a camera 68 for taking digital pictures and/or movies. Image and/or video files corresponding to the pictures and/or movies may be stored in the memory 42.

The electronic device 12 also may include a position data receiver 70, such as a global positioning system (GPS) receiver, Galileo satellite system receiver or the like. The position data receiver 70 may be involved in determining the location of the electronic device 12.

The electronic device 12 also may include a local wireless interface 72, such as an infrared transceiver and/or an RF interface (e.g., a Bluetooth interface), for establishing communication with an accessory, another mobile radio terminal, a computer or another device. For example, the local wireless interface 72 may operatively couple the electronic device 12 to a headset assembly (e.g., a PHF device) in an embodiment where the headset assembly has a corresponding wireless interface.

Although certain embodiments have been shown and described, it is understood that equivalents and modifications falling within the scope of the appended claims will occur to others who are skilled in the art upon the reading and understanding of this specification.

What is claimed is:

1. A method of monitoring communications associated with a mobile electronic device, comprising determining if a communication destined to the mobile electronic device is from a previously identified source and, if not, transmitting a notification of the communication to a supervisor's electronic device to inform a user of the supervisor's electronic device of the communication.

2. The method of claim 1, wherein the communication is one of a call or a message.

3. The method of claim 1, wherein the communication is a file or data transfer.

4. The method of claim 1, wherein the communication is a chat session.

5. The method of claim 1, wherein the notification is transmitted in the form of a message.

6. The method of claim 1, wherein the communication is allowed to take place if the source is not previously identified.

7. The method of claim 1, wherein the communication is not allowed to take place if the source is not previously identified.

8. The method of claim 1, wherein if the source is not previously identified, the communication is not allowed to take place until the user of the supervisor's electronic device authorizes the communication.

9. The method of claim 1, wherein identification information for previously identified sources is maintained in a contact list.

10. The method of claim 1, further comprising, upon initiation of a communication by the mobile electronic device, transmitting a notification of the initiated communication to the supervisor's electronic device to inform the user of the supervisor's electronic device of the initiated communication.

11. A method of monitoring communications associated with a mobile electronic device, comprising, upon initiation of a communication involving the mobile electronic device, transmitting a notification of the communication to a supervisor's electronic device to inform a user of the supervisor's electronic device of the communication.

12. The method of claim 11, wherein the communication is one of a call or a message.

13. The method of claim 11, wherein the communication is a file or data transfer.

14. The method of claim 11, wherein the communication is a chat session.

15. The method of claim 11, wherein the notification is transmitted in the form of a message.

16. The method of claim 11, further comprising blocking in the communication if a source or destination of the communication is not previously identified.

17. The method of claim 11, further comprising blocking in the communication until the user of the supervisor's electronic device authorizes the communication.

18. The method of claim 11, wherein the communication is initiated with the mobile electronic device.

19. A program stored on a computer readable medium, the program for monitoring communications associated with a mobile electronic device and comprising executable logic to determine if a communication destined to the mobile electronic device is from a previously identified source and, if not, transmit a notification of the communication to a supervisor's electronic device to inform a user of the supervisor's electronic device of the communication.

20. The program of claim 18, further comprising logic to transmit a notification of a communication initiated with the mobile electronic device to the supervisor's electronic device to inform the user of the supervisor's electronic device of the initiated communication.

21. A program stored on a computer readable medium, the program for monitoring communications associated with a mobile electronic device and comprising executable logic to transmit a notification of a communication involving the mobile electronic device to the supervisor's electronic device to inform the user of the supervisor's electronic device of the communication.
